(19) United States
(12) Patent Application Publication
(10) Pub. No.: US 2016/0348782 A1
(43) Pub. Date: Dec. 1, 2016

(54) SHIFT LEVER APPARATUS FOR VEHICLE

(71) Applicants: Hyundai Motor Company, Seoul (KR); Kia Motors Corporation, Seoul (KR); Kyung Chang Industrial Co., Ltd, Daegu (KR)

(72) Inventors: Doh Yon WON, Suwon-Si (KR); Joon Young PARK, Suwon-Si (KR); Myung Lyul NA, Hwaseong-Si (KR); Yong lk KIM, Ansan-Si (KR); Deok Ki KIM, Hwaseong-Si (KR); Won Jin JEONG, Hwaseong-Si (KR); Ji Soo KIM, Daegu (KR)

(73) Assignees: Hyundai Motor Company, Seoul (KR); Kia Motors Corporation, Seoul (KR); Kyung Chang Industrial Co., Ltd, Daegu (KR)

(21) Appl. No.: 14/934,462

(22) Filed: Nov. 6, 2015

(30) Foreign Application Priority Data
May 29, 2015 (KR) 10-2015-0076526

(51) Int. Cl. F16H 59/02; F16H 59/10; F16H 59/04

(52) U.S. Cl. CPC F16H 59/0204; F16H 59/0278; F16H 59/044; F16H 59/105; F16H 2059/0282

(57) ABSTRACT

A shift lever apparatus for a vehicle may include a shift lever configured to pivot in an antero-posterior direction to select an automatic mode shift stage or move in a left-right direction to select a manual mode, a rotational terminal configured to be rotated with the shift lever together when the shift lever is pivoted. an engaging lever including a switching mechanism connected with the shift lever on a side thereof and allowing the manual mode to be selected when the shift lever moves in the left-right direction and including a common contact electrically connected with a rotational terminal when the shift lever selects the manual mode, and a fixed terminal to selectively contact the rotational terminal of the shift lever and configured to select a Park (P) stage or an up-shift/down-shift stage which is a manual mode shift stage as the shift lever moves.

### CROSS-REFERENCE TO RELATED APPLICATION

The present application claims priority to Korean Patent Application Number 10-2015-0076526 filed May 29, 2015, the entire contents of which is incorporated herein for all purposes by this reference.

### BACKGROUND OF THE INVENTION

Field of the Invention

The present invention relates to a shift lever apparatus for a vehicle, and to a shift lever apparatus that achieves reduction of prime cost by simplifying a configuration forming a shift lever.

Description of Related Art

In an automatic transmission vehicle in the related art, in general, Park (P), Reverse (R), Neutral (N) and Drive (D) shift stages are linearly deployed and one of the shift stages may be selected by pivoting a shift lever and when the shift lever rotates, a cable is pulled, and as a result, operating force thereof is transferred to a transmission.

That is, since a point where the cable is connected to the shift lever is separated upward from a pivot center of the shift lever, when the shift lever is pivoted, as the cable is pulled or released according to a pivot angle, operating force thereof is transferred to the transmission, and as a result, shifting of the shift stage is performed by recognizing the transferred operating force.

Meanwhile, a shift lever device is configured to include an M shift stage which is a manual mode in addition to the P, R, N, and D shift stages and moves the shift lever to a direction vertical to a linear direction formed by the P, R, N, and D shift stages to select the manual mode. In the manual mode, it is configured in such a manner that + and − direction operations of the shift lever are detected by a signal of a sensor to be transferred to the transmission.

Meanwhile, when shifting to the P shift stage among the P, R, N, and D shift stages is performed, the shift is not just operated but a P-position switch needs to be operated. The P-position switch which is used for determining a P-stage shift will of a driver is provided in the shift lever or separately installed to perform the P-stage shift according to whether the driver intends to shift the P shift stage.

The shift lever device needs to include a sensor switch for detecting positions of + and − of the shift lever in the manual mode and further, needs to separately include a position switch for deciding the P shift stage, and as a result, manufacturing cost increases and a working process also increases.

Therefore, a scheme is required, which can reduce prime cost while maintaining a function of detecting the shift position in the manual mode and determining the shift will of the P shift stage.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a shift lever apparatus for a vehicle that integrates a system determining whether a P stage is shifted and whether an up-shift stage and a down-shift stage are shifted in a manual mode to reduce manufacturing cost and a manufacturing time.

According to various aspects of the present invention, a shift lever apparatus for a vehicle may include a shift lever configured to pivot in an antero-posterior direction to select an automatic mode shift stage or move in a left-right direction to select a manual mode, a rotational terminal that extends on an outer periphery of the shift lever in a pivot direction of the shift lever around a pivot center of the shift lever, and configured to be rotated with the shift lever together when the shift lever is pivoted, an engaging lever including a switching mechanism connected with the shift lever on a side thereof and allowing the manual mode to be selected when the shift lever moves in the left-right direction and including a common contact electrically connected with a rotational terminal when the shift lever selects the manual mode, and a fixed terminal provided to be disposed in the engaging lever to selectively contact the rotational terminal of the shift lever and configured to select a Park (P) stage or an up-shift/down-shift stage which is a manual mode shift stage as the shift lever moves.

The shift lever may be able to select the manual mode when moving in the left-right direction while selecting a Drive (D) stage in the automatic mode shift stage.

The switching mechanism of the engaging lever may include a switch member disposed in the engaging lever to be rotatable and rotating by contacting the shift lever at a time of selecting the manual mode of the shift lever, and a movable member provided to move vertically in link with the switch member when the switch member rotates and including a brush terminal that maintains a contact state with a common contact of the engaging lever.

The engaging lever may further include a manual mode terminal that is provided to be connected with the brush terminal of the movable member which moves at the time of selecting the manual mode of the shift lever to transfer a signal to select the manual mode at a time of connecting the brush terminal.

The movable member may be provided to be elastically supported on an elastic member fixedly disposed in the engaging lever.

A first contact protrusion may be formed in the rotational terminal, and as a result, the first contact protrusion may be selectively connected to contact a P stage or the up-shift stage or the down-shift stage which is the manual shift stage of the fixed terminal with the movement of the shift lever.

The fixed terminal may include a P stage contact, an up-shift contact, and a down-shift contact formed to contact the first contact protrusion, and the P stage contact, the up-shift contact, and the down-shift contact may be sequentially disposed to be separated in the pivot direction of the shift lever around the pivot center of the shift lever.

The up-shift contact and the down-shift contact of the fixed terminal may be disposed at locations opposite to the common contact based on the pivot center of the shift lever, respectively.

A second contact protrusion may be formed at a location symmetric to the first contact protrusion around the pivot center of the shift lever in the rotational lever, the first contact protrusion may selectively contact the P stage contact, the up-shift contact, and the down-shift contact with the movement of the shift lever, and the second contact protrusion may contact the common contact.

The common contact may extend in the pivot direction of the shift lever with a width which is the same as a distance with which the up-shift contact and the down-shift contact are separated from each other.

A preparatory contact may be provided at a location opposite to the P stage contact of the fixed terminal around the pivot center of the shift lever in the engaging lever.

A second contact protrusion may be formed at a location symmetric to the first contact protrusion around the pivot center of the shift lever in the rotational terminal, and as a result, the second contact protrusion may be connected to the preparatory contact when the first contact protrusion is connected to the P stage contact.

The up-shift contact and the down-shift contact of the fixed terminal may be disposed so that the first contact protrusion of the rotational terminal is positioned at a center where the up-shift contact and the down-shift contact are separated from each other at a time of selecting the manual mode while the shift lever selects the D stage in the automatic mode shift stage.

According to a shift lever apparatus for a vehicle, which has the aforementioned structure, systems determining whether a P stage is shifted and whether an up-shift stage and a down-shift stage are shifted in a manual mode are integrated to reduce manufacturing cost and a manufacturing time.

That is, in the related art, a P-stage position switch determining whether the P stage is shifted and a manual switch determining whether the up-shift stage and the down-shift stage are shifted in the manual mode are segmented, and as a result, the manufacturing cost increases, but in the present invention, the switches are integrated into one system, and as a result, the manufacturing cost is reduced.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary shift lever apparatus for a vehicle according to the present invention.

FIG. 2 and FIG. 3 are diagrams for describing an operation of a manual mode shift of the exemplary shift lever apparatus illustrated in FIG. 1.

FIG. 4 is a diagram illustrating the exemplary shift lever apparatus illustrated in FIG. 1.

FIG. 5, FIG. 6, FIG. 7, and FIG. 8 are diagrams for describing an operational status of the shift lever apparatus illustrated in FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

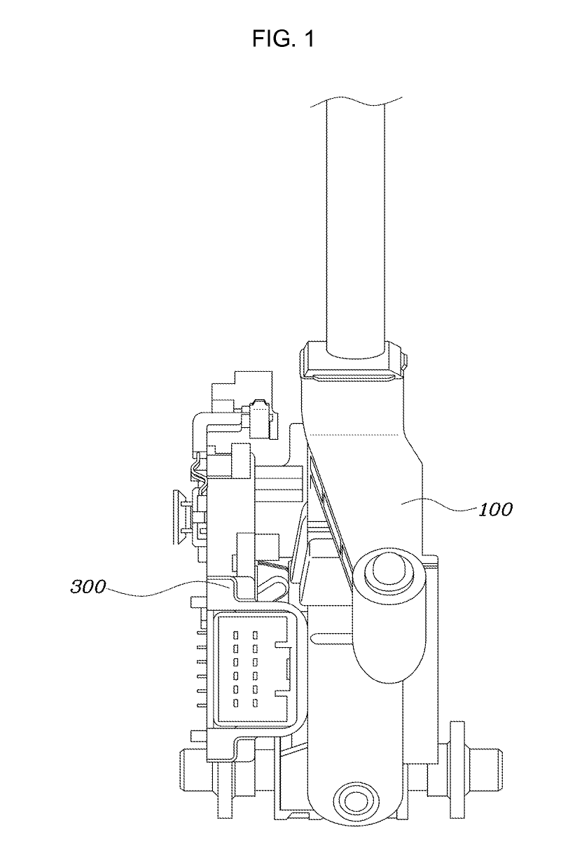

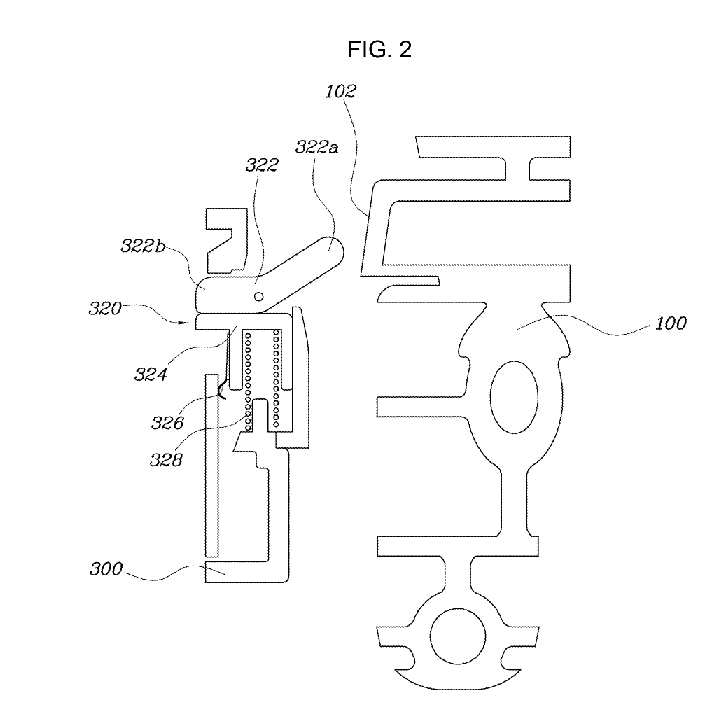

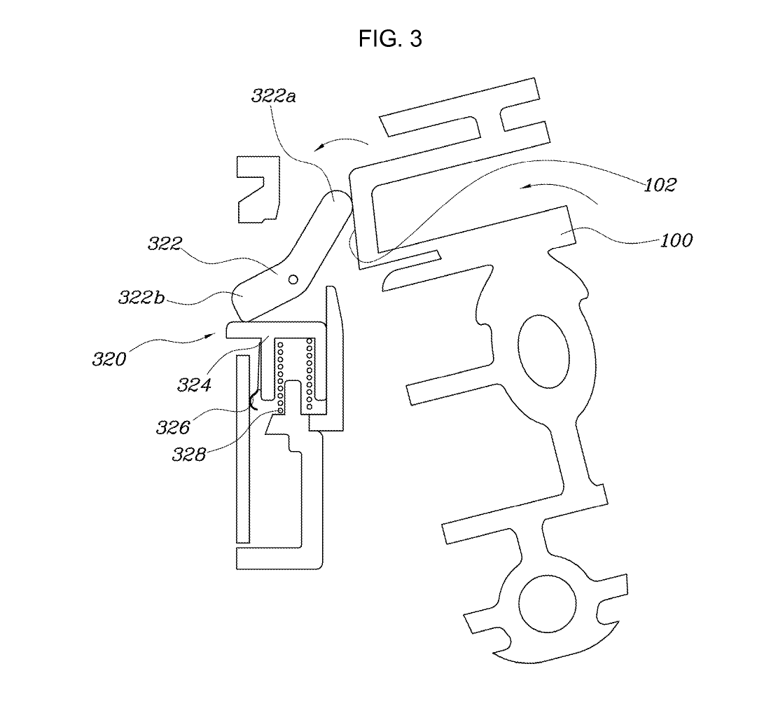

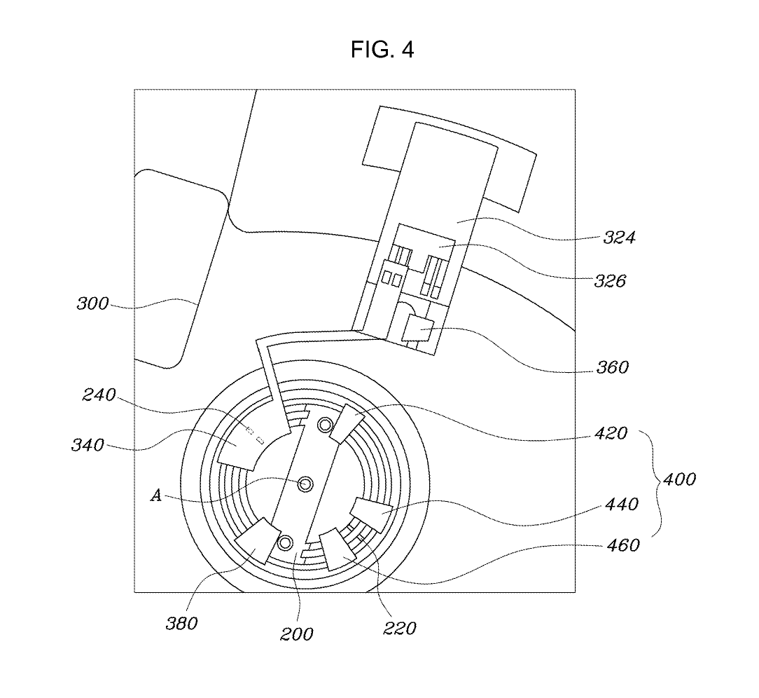

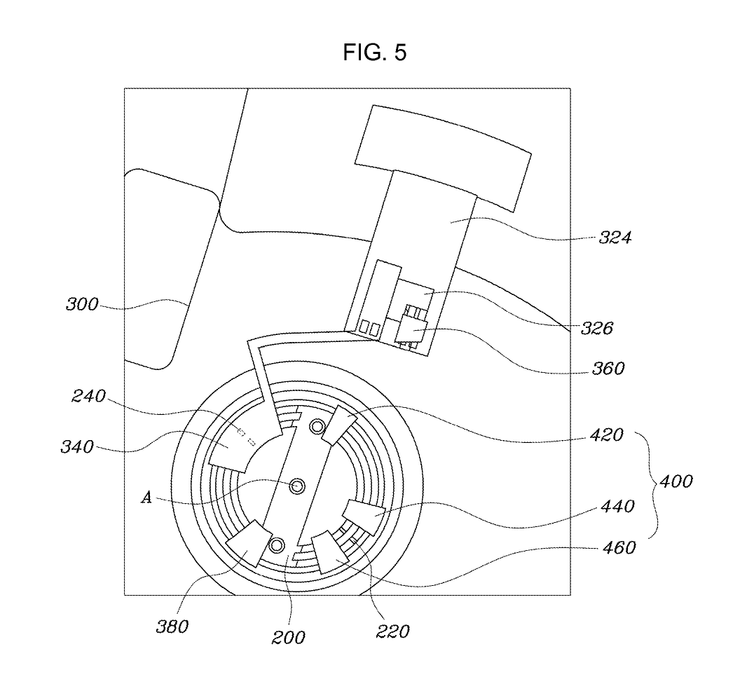

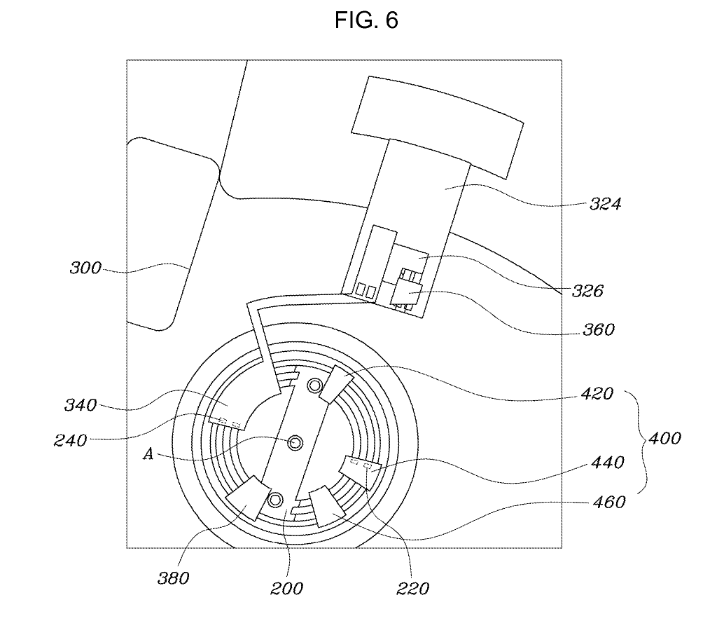

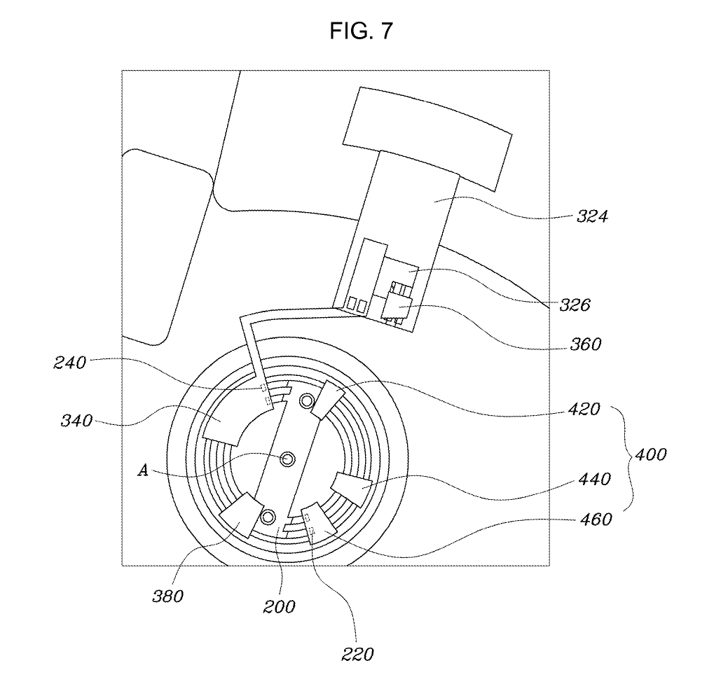

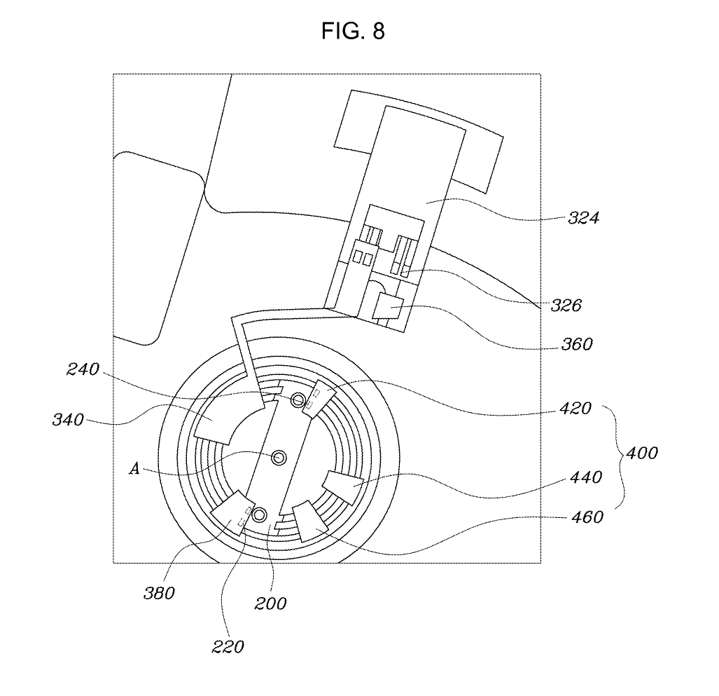

FIG. 1 is a diagram illustrating a shift lever apparatus for a vehicle according to various embodiments of the present invention. FIG. 2 and FIG. 3 are diagrams for describing an operation of a manual mode shift of the shift lever apparatus illustrated in FIG. 1. FIG. 4 is a diagram illustrating the shift lever apparatus illustrated in FIG. 1. FIG. 5, FIG. 6, FIG. 7, and FIG. 8 are diagrams for describing an operational status of the shift lever apparatus illustrated in FIG. 1.

As illustrated in FIGS. 1 to 4, the shift lever apparatus of the present invention includes a shift lever 100 provided to pivot in an antero-posterior direction to select an automatic mode shift stage or move in a left-right direction to select a manual mode, a rotational terminal 200 extended on an outer periphery of the shift lever 100 around a pivot direction of the shift lever 100 to rotates together when the shift lever 100 pivots, an engaging lever 300 including a switching mechanism 320 connected with the shift lever 100 on the side thereof and allowing the manual mode to be selected and including a common contact 340 electrically connected with the rotational terminal 200 when selecting the manual mode of the shift lever 100, and a fixed terminal 400 installed in the engaging lever 300 to selectively contact the rotational terminal 200 of the shift lever 100 and configured to a P stage or an up-shift/down-shift stage which is a manual mode shift stage to be selected with movement of the shift lever 100. Herein, as the rotational terminal 200 and the fixed terminal 400 are configured to transfer an electric signal, an electric cable is connected and this is apparent in a structure that transfers a signal between contact terminals, and as a result, a detailed description is omitted.

The shift lever 100 of the present invention is provided to select Park (P), Reverse (R), Neutral (N) and Drive (D) stages which are automatic mode shift stages while pivoting in the antero-posterior direction and select an M stage in the manual mode while moving in the left-right direction. In particular, the shift lever 100 is configured to select the manual mode in the left-right direction while selecting the D stage in the automatic mode shift stage and configured to be switched from the D stage which is a drive shift stage into the manual mode to up-shift or down-shift the shift stage the shift stage.

Meanwhile, the rotational terminal 200 that is extended in the pivoting direction of the shift lever 100 to rotate together when the shift lever 100 pivots is provided on the outer periphery of the shift lever 100 around the pivot center A. The rotational terminal 200 is configured to be installed in the engaging lever 300 and rotate in link with an operation of the shift lever 100 and is electrically connected with various shift stage contacts provided in the engaging lever 300 to be described below with the operation of the shift lever 100 to transfer the signal of the corresponding shift stage.

The engaging lever 300 includes the switching mechanism 320 which is connected to the side of the shift lever 100 and operates in link with the shift lever 100 when moving in the left-right direction of the shift lever 100 and the common contact 340 electrically connected with the rotational terminal 200. Herein, the switching mechanism 320 is configured to transfer a signal to switch the current mode to the manual mode when moving the left-right direction in the D shift stage and the common contact 340 is configured to transfer a positional signal as the shift lever 100 pivots while the current mode is switched to the manual mode. This will be described below in detail.

Meanwhile, the fixed terminal 400 is provided to transfer the signal of the P stage or the up-shift/down-shift stage which is the manual mode shift stage and the fixed terminal 400 is installed in the engaging lever 300 to selectively contact the rotational terminal 200 of the shift lever 100 to thereby transfer the signal shifted to the P stage or the up-shift stage or down-shift stage.

In the present invention, referring to FIGS. 1 and 4, when the shift lever 100 pivots in the antero-posterior direction, the automatic mode shift stage is selected, while in the case of the P stage, the rotational terminal 200 that rotates together with the shift lever 100 selects the P shift stage of the fixed terminal 400, the resulting signal is transferred to permit the P stage to be shifted.

Further, when the shift is performed by the switch to the manual mode, the switching mechanism 320 installed in the engaging lever 300 transfers the signal to switch the automatic mode into the manual mode by moving the shift lever 100 in the left-right direction and as the rotational terminal 200 contacts the up-shift stage or the down-shift stage of the fixed terminal 200 while the up-shift or down-shift is performed by operating the shift lever 100, the resulting signal is transferred, and as a result, the up-shift or down-shift in the manual mode is performed.

That is, in the present invention, the P shift stage and the up-shift and down-shift stage is enabled to be performed through the rotational terminal 200 installed in the shift lever 100 and the fixed terminal 400 installed in the engaging lever 300, and as a result, the P stage and manual mode shift stage position detecting systems are integrated. Therefore, as systems that check the P shift stage and the shift stage in the manual mode are not individually provided, manufacturing cost is reduced.

When the present invention is described in detail, as illustrated in FIGS. 2 and 3, the switching mechanism 320 of the engaging lever 300 is constituted by a switch member that is installed in the engaging lever 300 to be rotatable and rotates to contact the shift lever 100 at the time of selecting the manual mode of the shift lever 100, and a movable member 324 that is provided to move vertically in link with the switch member 322 when the switching member 322 rotates and includes a brush terminal 326 which maintains a contact state with the common contact 340. Herein, the movable member 324 is elastically supported on an elastic member 328 fixedly installed in the engaging lever 300, and as a result, the movable member 324 may return to an original position by elastic force of the elastic member 328 when the shift lever 100 returns to the automatic mode shift stage again.

Further, the engaging lever 300 further includes a manual mode terminal 360 that is provided to be connected with a brush terminal 326 of the movable member 324 which moves at the time of selecting the manual mode of the shift lever 100 to transfer a signal to select the manual mode when being connected with the brush terminal 326.

That is, as illustrated in FIG. 2, the switching mechanism 320 of the engaging lever 300 is constituted by the switch member 322 and the movable member 324, and the switch member 322 is configured to be installed in the engaging lever 300 to be rotatable to rotate by contacting the shift lever 100 when the shift lever 100 moves in the left-right direction. Herein, a contact inclined surface 102 is formed in the shift lever 100 and a contact protrusion 322a corresponding to the contact inclined surface 102 is formed at one end portion of the switch member 322, and as a result, the contact protrusion 322a of the switch member 322 moves along the contact inclined surface 102 of the shift lever 100 when the shift lever 100 moves to smoothly rotate the switch member 322.

As such, a rotational protrusion 322b may be formed at the other end portion of the switch member 322 that rotates and as illustrated in FIG. 3, as the switch member 322 rotates by the shift lever 100, the rotational protrusion 322b pushes the movable member 324 to move the movable 324 downward. As a result, as illustrated in FIG. 5, the brush terminal 326 provided in the movable member 324 moves downward and as the brush terminal 326 contacts the manual mode terminal 360 installed in the engaging lever 300, the signal depending on the manual mode is transferred to perform the shift to the manual mode.

Herein, the brush terminal 326 is configured to maintain the contact state with the common contact 340 of the engaging lever 300 and this used to transfer the signal at the time of switching the automatic mode into the manual mode is used to the signal for the up-shift stage and the down-shift stage which are the manual mode shift stages to be described below while the brush terminal 326 contacts the manual mode terminal 360.

Meanwhile, as illustrated in FIG. 4, a first contact protrusion 220 is formed in the rotational terminal 200 and as the shift lever 100 moves, the first contact protrusion 220 may be selectively connected to contact the P stage or the up-shift stage or the down-shift stage which are the manual shift stages.

Herein, the fixed terminal 400 is constituted by a P stage contact 420, an up-shift contact 440, and a down-shift contact 460 formed to contact the first contact protrusion 220 and the P stage contact 420, the up-shift contact 440, and the down-shift contact 460 may be installed to be sequentially separated in the pivot direction of the shift lever 100 around the pivot center A of the shift lever 100. The P stage contact 420, the up-shift contact 440, and the down-shift contact 460 of the fixed terminal 400 may be installed in opposite installation directions to each other.

In particular, the up-shift contact 440 and the down-shift contact 460 of the fixed terminal 400 may be installed so that the first contact protrusion 220 of the rotational terminal 200 is positioned at the center where the up-shift contact 440 and the down-shift contact 460 are separated from each other when the shift lever 100 selects the manual mode while selecting the D stage in the automatic mode shift stage. As a result, when the shift lever 100 selects the manual mode in the D stage, as the first contact protrusion 220 is positioned at the center between the up-shift contact 440 and the down-shift contact 460, shift strokes of the up-shift and the down-shift are formed at the same interval.

That is, in the present invention, the rotational terminal 200 rotates in link with the shift lever 100 when the shift lever 100 pivots in the antero-posterior direction, the first contact protrusion 220 contacts the P stage contact 420 to perform the shift to the P stage and when the shift lever 100 is switched to the manual mode in the D shift stage and thereafter, pivots in the antero-posterior direction, the first contact protrusion 220 selectively contacts the up-shift contact 440 or the down-shift contact 460 to perform the up-shift or the down-shift in the manual mode.

In detail, a second contact protrusion 240 is formed at a location symmetric to the first contact protrusion 220 around the pivot center A of the shift lever 100 and the first contact protrusion 220 may selectively contact the P stage contact 420, the up-shift contact 440, and the down-shift contact 460 with the movement of the shift lever 100 and the second contact protrusion 240 may contact the common contact 340.

As such, in the rotational terminal 200, as the first contact protrusion 220 and the second contact protrusion 240 are formed, the first contact protrusion 220 contacts the up-shift contact 440 or the down-shift contact 460 by operating the shift lever 100, the second contact protrusion 240 is connected to the common contact 340, and as a result, the signal as the shift lever 100 selects the manual mode is transferred and input into the first contact protrusion 220 through the common contact 340 and simultaneously, the signal for the up-shift stage or the down-shift stage is input through the second contact protrusion 240 connected to the up-shift contact 440 or the down-shift contact 460 to perform the shift in the manual mode.

Herein, the up-shift contact 440 and the down-shift contact 460 of the fixed terminal 400 may be installed to be separated at locations opposite to the common contact 340 around the pivot center A of the shift lever 100, respectively. As such, the up-shift contact 440 and the down-shift contact 460 of the fixed terminal 400 are formed at the locations opposite to the common contact 340 and the first contact protrusion 220 and the second contact protrusion 240 of the rotational terminal 200 are also formed to be opposite to each other, and as a result, interference between the respective electric cables may be prevented and it is possible to prevent an error of the signal transferring, which is caused as the respective contacts get close to each other.

Further, the common contact 340 may extend in the pivot direction of the shift lever 100 with a width which is the same as or larger than a distance with the up-shift contact 440 and the down-shift contact 460 are separated from each other. As a result, when the first contact protrusion 220 of the rotational terminal 200 is selectively connected to the up-shift contact 440 or the down-shift contact 460, the second contact protrusion 240 maintains a connection state with a common terminal, and as a result, a shift signal to the up-shift stage or the down-shift stage may be determined while it is recognized that the manual mode is entered.

Meanwhile, a preparatory contact 380 may be provided at a location opposite to the P stage contact 420 of the fixed terminal 400 around the pivot center A of the shift lever 100.

Herein, the second contact protrusion 240 is formed at the location symmetric to the first contact protrusion 220 around the pivot center A of the shift lever 100 and when the first contact protrusion 220 contacts the P stage contact 420, the second contact protrusion 240 may be connected to the preparatory contact 380.

That is, when the shift lever 100 pivots in the antero-posterior direction to select the P stage in the automatic mode shift stage, the first contact protrusion 220 of the rotational terminal 200 may contact the P stage contact 420 and the second contact protrusion 240 is connected to the preparatory contact, and as a result, the signal for the P shift stage may be input. Herein, the preparatory contact which is provided to smoothly transfer an electric signal of the rotational terminal 200 may be formed at a location opposite to the P stage contact 420.

Hereinafter, an operation of the shift lever apparatus of the present invention will be described with reference to drawings.

In FIG. 4, driving is performed by selecting the D stage in the automatic mode shift stage and in the case of the D stage, the corresponding shift stage is decided by pulling the cable as the shift lever 100 pivots in the antero-posterior direction.

As such, while the D stage is selected as the shift stage of the shift lever 100, as the shift lever 100 moves in the left-right direction at the time of selecting the manual mode, the movable member 324 of the operating mechanism moves downward as illustrated in FIG. 5. As a result, the brush terminal 326 of the movable member 324 moves downward to contact the manual mode terminal 360 installed in the engaging lever 300 and the signal by the selection of the manual mode is transferred to switch the current mode into the manual mode.

In such a state, as illustrated in FIG. 6, when the shift stage is up-shifted, as the shift lever 100 moves forward, the rotational terminal 200 rotates, and as a result, the first contact protrusion 220 contacts the up-shift contact 440 to perform the shift to the up-shift stage and as illustrated in FIG. 7, when the shift stage is down-shifted, as the shift lever 100 moves backward, the rotational terminal 200 rotates, and as a result, the first contact protrusion 220 contacts the down-shift contact 460 to perform the shift to the down-shift stage. In this case, the second contact protrusion 240 of the rotational terminal 200 maintains the contact state with the common terminal even though the first contact protrusion 220 moves to the up-shift contact 440 and the second contact protrusion 240.

Meanwhile, in FIG. 7, the shift lever 100 selects the P stage and when the shift lever 100 pivots to the P stage in the automatic mode shift stage, as the rotational terminal 200, the first contact protrusion 220 contacts the P stage contact 420 and the second contact protrusion 240 is connected to the preparatory contact 380. As a result, the signal depending on the P stage is transferred to permit the shift to the P stage and in this case, as the brush terminal 326 of the switching mechanism 320 does not contact the manual mode terminal 360, the shift to the P stage is performed.

According to the shift lever apparatus for a vehicle, which has the aforementioned structure, systems determining whether the P stage is shifted and whether the up-shift stage and a down-shift stage are shifted in the manual mode are integrated to reduce manufacturing cost and a manufacturing time.

That is, in the related art, the P-stage position switch determining whether the P stage is shifted and a manual switch determining whether the up-shift stage and the down-shift stage are shifted in the manual mode are segmented, and as a result, the manufacturing cost increases, but in the present invention, the switches are integrated into one system, and as a result, the manufacturing cost is reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shift lever apparatus for a vehicle, the apparatus comprising:
a shift lever configured to pivot in an antero-posterior direction to select an automatic mode shift stage or move in a left-right direction to select a manual mode;
a rotational terminal that extends on an outer periphery of the shift lever in a pivot direction of the shift lever around a pivot center of the shift lever, and configured to be rotated with the shift lever together when the shift lever is pivoted;
an engaging lever including a switching mechanism connected with the shift lever on a side thereof and allowing the manual mode to be selected when the shift lever moves in the left-right direction and including a common contact electrically connected with a rotational terminal when the shift lever selects the manual mode; and
a fixed terminal provided to be disposed in the engaging lever to selectively contact the rotational terminal of the shift lever and configured to select a Park (P) stage or an up-shift/down-shift stage which is a manual mode shift stage as the shift lever moves.

2. The shift lever apparatus of claim 1, wherein the shift lever is able to select the manual mode when moving in the left-right direction while selecting a Drive (D) stage in the automatic mode shift stage.

3. The shift lever apparatus of claim 1, wherein the switching mechanism of the engaging lever includes:
a switch member disposed in the engaging lever to be rotatable and rotating by contacting the shift lever at a time of selecting the manual mode of the shift lever; and
a movable member provided to move vertically in link with the switch member when the switch member rotates and including a brush terminal that maintains a contact state with a common contact of the engaging lever.

4. The shift lever apparatus of claim 3, wherein the engaging lever further includes a manual mode terminal that is provided to be connected with the brush terminal of the movable member which moves at the time of selecting the manual mode of the shift lever to transfer a signal to select the manual mode at a time of connecting the brush terminal

5. The shift lever apparatus of claim 3, wherein the movable member is provided to be elastically supported on an elastic member fixedly disposed in the engaging lever.

6. The shift lever apparatus of claim 1, wherein a first contact protrusion is formed in the rotational terminal, and as a result, the first contact protrusion is selectively connected to contact a P stage or the up-shift stage or the down-shift stage which is the manual shift stage of the fixed terminal with the movement of the shift lever.

7. The shift lever apparatus of claim 6, wherein the fixed terminal comprises a P stage contact, an up-shift contact, and a down-shift contact formed to contact the first contact protrusion, and the P stage contact, the up-shift contact, and the down-shift contact are sequentially disposed to be separated in the pivot direction of the shift lever around the pivot center of the shift lever.

8. The shift lever apparatus of claim 7, wherein the up-shift contact and the down-shift contact of the fixed terminal are disposed at locations opposite to the common contact based on the pivot center of the shift lever, respectively.

9. The shift lever apparatus of claim 8, wherein a second contact protrusion is formed at a location symmetric to the first contact protrusion around the pivot center of the shift lever in the rotational lever, the first contact protrusion selectively contacts the P stage contact, the up-shift contact, and the down-shift contact with the movement of the shift lever, and the second contact protrusion contacts the common contact.

10. The shift lever apparatus of claim 8, wherein the common contact extends in the pivot direction of the shift lever with a width which is the same as a distance with which the up-shift contact and the down-shift contact are separated from each other.

11. The shift lever apparatus of claim 7, wherein a preparatory contact is provided at a location opposite to the P stage contact of the fixed terminal around the pivot center of the shift lever in the engaging lever.

12. The shift lever apparatus of claim 11, wherein a second contact protrusion is formed at a location symmetric to the first contact protrusion around the pivot center of the shift lever in the rotational terminal, and as a result, the second contact protrusion is connected to the preparatory contact when the first contact protrusion is connected to the P stage contact.

13. The shift lever apparatus of claim 7, wherein the up-shift contact and the down-shift contact of the fixed terminal are disposed so that the first contact protrusion of the rotational terminal is positioned at a center where the up-shift contact and the down-shift contact are separated from each other at a time of selecting the manual mode while the shift lever selects the D stage in the automatic mode shift stage.
